(19) United States
(12) Patent Application Publication
(10) Pub. No.: US 2014/0229431 A1
(43) Pub. Date: Aug. 14, 2014

(54) SYSTEM AND METHOD FOR LOCALLY STORING FILES FROM A SYSTEM SERVER

(71) Applicant: APPSENSE LIMITED, Warrington (GB)

(72) Inventor: Richard James SOMERFIELD, San Jose, CA (US)

(73) Assignee: APPSENSE LIMITED, Warrington (GB)

(21) Appl. No.: 13/763,595

(22) Filed: Feb. 8, 2013

(51) Int. Cl. G06F 17/30

(52) U.S. Cl. CPC G06F 17/30575; G06F 17/30371
USPC 707/610; 707/690

(57) ABSTRACT

Embodiments of the invention include a system and method for allowing a company or organization to synchronize data files between a company computer storage, such as a computer memory or a file server, and various user computers networked to the company computer. As such, the system provides a method for determining which data files are most likely to be needed by the user, and copying data files that are the most needed to the user computer. In the process of copying the files to the user computer, the system determines which data files are no longer needed on the user computer, and replaces the data files that are no longer needed on the user computer with new data files that the system has determined are more likely to be needed by the user.

### FIELD OF INVENTION

The invention relates generally to file synchronization systems and more particularly to a system, method, and computer program product for ranking files in a user computer memory so that the most useful files stored on a company computer for a particular user are also stored in the memory of the user computer.

### BACKGROUND OF THE INVENTION

In a typical computer, file synchronization (or syncing) in computing is the process of ensuring that computer files in two or more locations are updated via certain rules.

Computer users are creating ever increasing volumes of data files, which can easily overwhelm the memory of each user's computer. To ease the burden on user computer memory, these data files are often stored in remote or networked storage (e.g., a file server). However, to obtain the data files from the remote or networked computer storage, the user must establish a connection to the remote or networked storage through a communications network, which can delay file access. To speed up access, many companies use file synchronization software that copies each user's important data files to the user computer memory for ease of access. In some instances, the file synchronization software will manage only the files that belong to a single user. Typically, however, the data files stored on the network are also available, through the file-synchronization software, to other user computers. For example, a file synchronization software within a company may synchronize all of the company's documents with all of the user computers served by the company's network. This allows, for example, users in a department to access the data files of other users in the same department.

There are many benefits to file synchronization. Because data files are locally available, the data files may be opened more quickly, they are automatically kept up-to-date, and the user's computer does not need to maintain a permanent connection to network storage to obtain a frequently accessed data file. However, the network storage can store more data files than the storage capacity of the user computer, so there is a risk that the data file the user needs will not be stored in the user's computer memory. Such delivery can be optimized by requiring the user to configure the file-synchronization software, or by only synchronizing file contents when the user tries to open a file stored on the network. In prior art file-synchronization systems, therefore, the user selectively choses which data files and/or folders having data files should be synchronized locally from the files the user accesses on the server.

There are disadvantages to the above methods of file synchronization. For instance, the user may access files that it needs temporarily, forcing files it needs more often to be removed from user computer storage in favor of a file that has been opened more recently (but is less important to the user). Moreover, if a user must preconfigure the file synchronization system to synchronize certain data files, often the user will not do so, leading the user to circumvent the file synchronization software and access files ‘on-demand.’ For example, the user will typically only request files at the time he wants to access them. Therefore, the user will still need a permanent network connection and will experience delays in accessing data files because those data files must be obtained from the server.

A need exists, therefore, for a system, method and computer program product that solves the issues identified above.

### SUMMARY OF INVENTION

In accordance with the disclosed subject matter, a system, method and computer program product are provided for synchronizing data files.

Embodiments of the invention include a system that comprises a computer having a processor and a tangible, non-transitory computer memory with instructions operable therein for performing on the processor a process of determining data files that should be synchronized with a user computer and a process of synchronizing the data files. In some embodiments, the instructions comprise the steps of receiving a local list of data files stored in the user computer; responsive to receiving the local list, determining a set of data files associated with a user; determining a rank for each data file in the set based on at least one of: whether the user is associated with another user that has recently created the data file, and whether the data file can be downloaded within a predefined time period; creating a ranked list ordered by the rank determined for each data file in the set; creating a new list of data files from the data files associated with higher ranks in the ranked list, the data files in the new list having a cumulative size that is less than a memory size of the user computer; and comparing the new list with the local list to determine which of the data files in the new list are missing from the user computer.

Embodiments of the invention include a computer program product operable on a computer having a tangible, non-transitory computer memory, the computer program product causing the computer to perform a process of determining data files that should be synchronized with a user computer and a process of synchronizing the data files. In some embodiments, the computer program product executes instructions comprising the steps of receiving a local list of data files stored in the user computer; responsive to receiving the local list, determining a set of data files associated with a user; determining a rank for each data file in the set based on at least one of whether the user is associated with another user that has recently created the data file, and whether the data file can be downloaded within a predefined time period; creating a ranked list ordered by the rank determined for each data file in the set; creating a new list of data files from the data files associated with higher ranks in the ranked list, the data files in the new list having a cumulative size that is less than a memory size of the user computer; and comparing the new list with the local list to determine which of the data files in the new list are missing from the user computer.

Embodiments of the invention include a computer implemented method causing a computer to perform a process of determining data files that should be synchronized with a user computer and a process of synchronizing the data files. In some embodiments, the computer-implemented method comprises the steps of receiving a local list of data files stored in the user computer; responsive to receiving the local list, determining a set of data files associated with a user; determining a rank for each data file in the set based on at least one of: whether the user is associated with another user that has recently created the data file, and whether the data file can be downloaded within a predefined time period; creating a ranked list ordered by the rank determined for each data file in the set; creating a new list of data files from the data files associated with higher ranks in the ranked list, the data files in the new list having a cumulative size that is less than a memory size of the user computer; and comparing the new list with the local list to determine which of the data files in the new list are missing from the user computer.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

So that the features and advantages of the invention may be understood in more detail, a more particular description of the invention briefly summarized above may be had by reference to the appended drawings, which form a part of this specification. It is to be noted, however, that the drawings illustrate only various embodiments of the invention and are therefore not to be considered limiting of the invention's scope as it may include other effective embodiments as well.

FIG. 1 is a network diagram according to an embodiment of the invention;

FIG. 2A is an electronic block diagram of a company computer according to embodiment of the invention;

FIG. 2B is an electronic block diagram of a user computer according to an embodiment of the invention;

FIG. 3 is a software block diagram for software stored on a company computer according to an embodiment of the invention;

FIG. 4 is a software block diagram for software stored on a user computer according to an embodiment of the invention;

FIGS. 5A-5E are software flow diagrams for software stored on a company computer according to embodiments of the invention;

FIGS. 6A-6D are software flow diagrams for software stored on a user computer according to embodiments of the invention;

FIG. 7 is an exemplary list for use in an embodiment of the invention.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are exemplary, and that it is contemplated that there are other systems and methods that are within the scope of the disclosed subject matter.

To address the needs discussed above, embodiments of the invention include a system for allowing a company or organization to synchronize data files between a company computer storage, such as a computer memory or a file server, and various user computers networked to the company computer. As such, the system provides a method for determining which data files are most likely to be needed by the user, and copying data files that are the most needed to the user computer. In the process of copying the files to the user computer, the system determines which data files are no longer needed on the user computer, and replaces the data files that are no longer needed on the user computer with new data files that the system has determined are more likely to be needed by the user.

As will be understood by those of skill in the art, the term company computer may be a computer, computer server or computer network associated with a particular company, or organization. As such, the term company computer is not limited to commercial companies, but may include other organizations such as education institutions, charities, non-profit groups, government entities, financial institutions, etc. Moreover, the terms company and organization should not be limited to a single entity, but can include multiple entities, corporations, organizations, charities and/or individuals having access to a secure server and database. As such, in some embodiments, the company computer may be a shared server where one or more users can upload computer content.

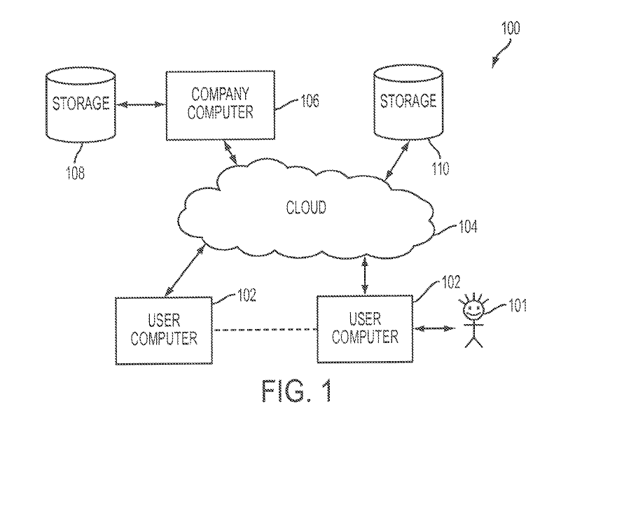

FIG. 1 is a system diagram according to an embodiment of the invention. System 100 of the present invention includes one or more user computers 102 (i.e., 102-1, . . . , 102-N) associated with a user 101 to enable the user to access a company computer 106. A communications network 104 is positioned between the user computer 102 and the company computer 106 to provide the user 101, via user computer 102, local or remote access to the company computer 106 (e.g., so that the user and the company computer can be located in same physical location or in different physical locations). The company computer 106 may connect to a storage 108 (e.g., a file server). The company storage 108 stores company data files that the user 101 can access through the communications network.

As one skilled in the art will appreciate, the user computer 102 can be any computing device capable of connecting to the communications network 104 and receiving data from same. As such, the user computer 102 enables the user to interact with the company computer 106 to view, store and retrieve data files. For example, the user computer 102 may be a desktop, laptop, personal digital assistant (PDA), cellular telephone such as a Smartphone, computer tablet, networked computer display, computer server, WebTV, as well as any other electronic device. As such, the user computer 102 is connected to the company computer 106 via communications network 104, which may be a single communications network or comprised of several different communications networks, to connect the system.

As one skilled in the art will appreciate, in one embodiment, communications network 104 establishes a computing cloud. A computing cloud can be, for example, the software implementing one or more of the company computer, third party database and application that is hosted by a cloud provider and exists in the cloud. The communications network 104 can also be a combination of a public or private network, which can include any combination of the Internet and intranet systems that allow a plurality of system users to access the company computer 106. For example, communications network 104 can connect all of the system components using the internet, a local area network (“LAN”) such as Ethernet or Wi-Fi, or wide area network (“WAN”) such as LAN to LAN via internet tunneling, or a combination thereof, using electrical cable such as HomePNA or power line communication, optical fiber, or radio waves such as wireless LAN, to transmit data. As one skilled in the art will appreciate, in some embodiments, user computer 102 may be connected to the communications network using a wireless LAN, but other users may be connected to the company computer 106 via a wired connection to the internet. In other embodiments, a user may connect to the company computer 106 using a wireless LAN and the internet. Moreover, the term “communications network” is not limited to a single communications network system, but may also refer to several separate, individual communications networks used to connect the user computer 102 to company computer 106. Accordingly, though each of the user computer 102 and company computer 106 is depicted as connected to a single communications network, such as the internet, an implementation of the communications network 104 using a combination of communications networks is within the scope of the invention.

As one skilled in the art will appreciate, in cloud implementations, the communications network 104 interfaces with company computer 106, preferably via a firewall and web server (both not shown) to provide a secure access point for users 101 and to prevent users 101 from accessing the various protected portions of the storage 108 in the system. The firewall may be, for example, a conventional firewall as discussed in the prior art.

Storage 108 communicates with and uploads and stores data files to the user computer 102 via the company computer 106 and communications network 104. As one skilled in the art will appreciate, though storage 108 is depicted as a database, storage 108 may be implemented in, one or more computers, file servers and/or database servers. As such, the storage 108 may be implemented as network attached storage (NAS), storage area network (SAN), direct access storage (DAS), or any combination thereof, comprising for example multiple hard disk drives. Moreover, each of these file servers or database servers may allow a user 101 to upload or download data files to the database. For example, a user may have an associated username, password, RSA code, etc., that allows the user to store or retrieve various files to storage 108. These files can be stored in one or more computers comprising the storage 108 in a plurality of software databases, tables, or fields in separate portions of the file server memory (e.g., employee records, corporate records, projects, meeting items and agendas, memos, email, letters, financial and account information, payroll records, HR records, etc.). Accordingly, as is known in the art, the computer implementing storage 108 may have stored thereon a database management system (e.g., a set of software programs that controls the organization, storage, management, and retrieval of data in the computer). As one skilled in the art will appreciate, in some embodiments, storage 108 may be a software database stored in the company computer memory (to be discussed below). As one skilled in the art will also appreciate, though storage 108 is depicted as connected to, or as a part of, the company computer 106 (and not the communications network 104), the storage 108 may be, for example, a remote storage connected to the company computer 106 via the cloud or connected to the company computer 106 via a privately networked system.

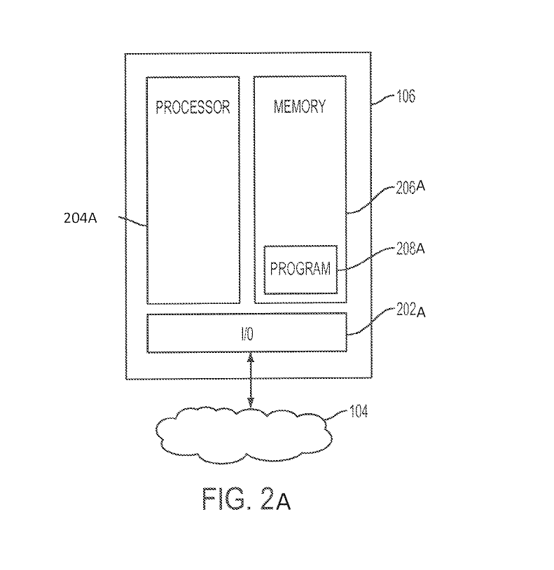

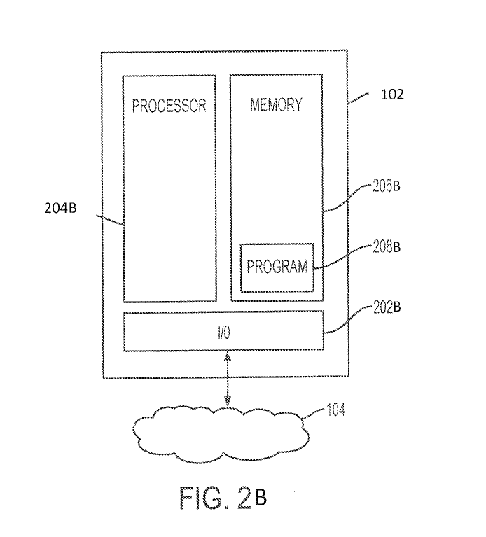

Company computer 106 will now be described with reference to FIG. 2A. As one skilled in the art will appreciate, company computer 106 can be any type of computer such as a virtual computer, application server, or a plurality of computers (e.g., a dedicated computer server, desktop, laptop, personal digital assistant (PDA), cellular telephone such as a Smartphone, computer tablet, WebTV, as well as any other electronic device). As such, company computer 106 may comprise a memory 206A, a program product 208A, a processor 204A and an input/output (“I/O”) device 202A. I/O device 202A connects the company computer 106 to a signal from the communications network 104, and can be any I/O device including, but not limited to a network card/controller connected by a bus (e.g., PCI bus) to the motherboard, or hardware built into the motherboard to connect the company computer 106 to various file servers or database servers implementing storage 108.

Processor 204A is the “brains” of the company computer 106, and as such executes program product 208A and works in conjunction with the I/O device 202A to direct data to memory 206A and to send data from memory 206A to the various file servers and communications network. Processor 204A can be, for example, any commercially available processor, or plurality of processors, adapted for use in company computer 106 (e.g., Intel® Xeon® multicore processors, Intel® micro-architecture Nehalem, AMD Opteron™ multicore processors, etc.). As one skilled in the art will appreciate, processor 204A may also include components that allow the company computer 106 to be connected to a display, keyboard, mouse, trackball, trackpad and/or any other user input/output device (not shown), that would allow, for example, an administrative user direct access to the processor 204A and memory 206A.

Memory 206A may store the algorithms forming the computer instructions of the instant invention and data. Memory 206A may include both non-volatile memory such as hard disks, flash memory, optical disks, and the like, and volatile memory such as SRAM, DRAM, SDRAM, and the like, as required by embodiments of the instant invention. As one skilled in the art will appreciate, though memory 206A is depicted on, for example, the motherboard of the company computer 106, memory 206A may also be a separate component or device connected to the company computer 106. For example, memory 206A may be flash memory, external hard drive, or other storage.

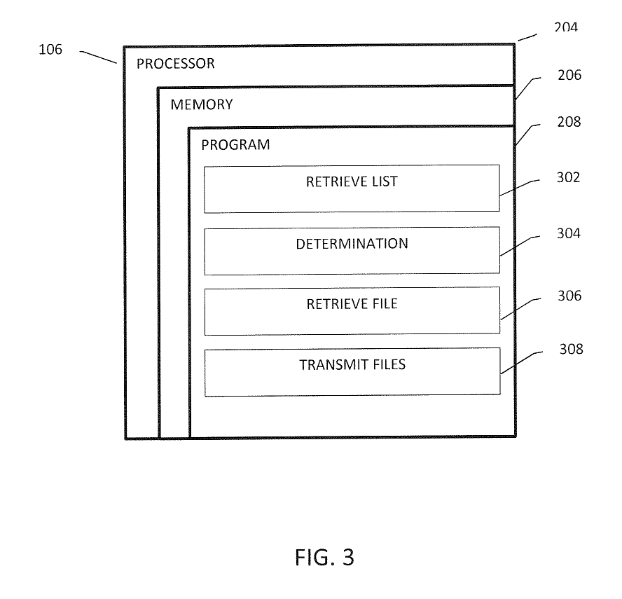

As shown in FIG. 2A, an embodiment for computer instructions forming computer programming product 208A implementing some of the functionality of the company computer 106 is stored in memory 206A (e.g., as a plurality of programming modules). Turning now to FIG. 3, the programming modules of the computer program product 208A stored in memory 206A may include a retrieve list module 302, a determination module 304, a retrieve file module 306, and transmit files module 308.

The retrieve list module 302 can include instructions that enable company computer 106 to connect to and download a list of files stored in user computer memory of the user computer 102. For example, the retrieve list module 302 may be called when the user connects to the company computer 106 to retrieve a file. In some embodiments, the retrieve list module may be called at regular time intervals, which would require the company computer 106 to establish a connection through the communication network 104.

The determination module 304 can include instructions so that company computer 106 can determine whether a new list of files the user computer 102 has stored thereon are most relevant to the user. The retrieve file module 306 can include instructions to retrieve files from memory and works with the transmit files module 308 to send to the user computer 102 a list of files that should be stored on the user computer 102 and any data files that are on the list that are not currently stored on the user computer 102.

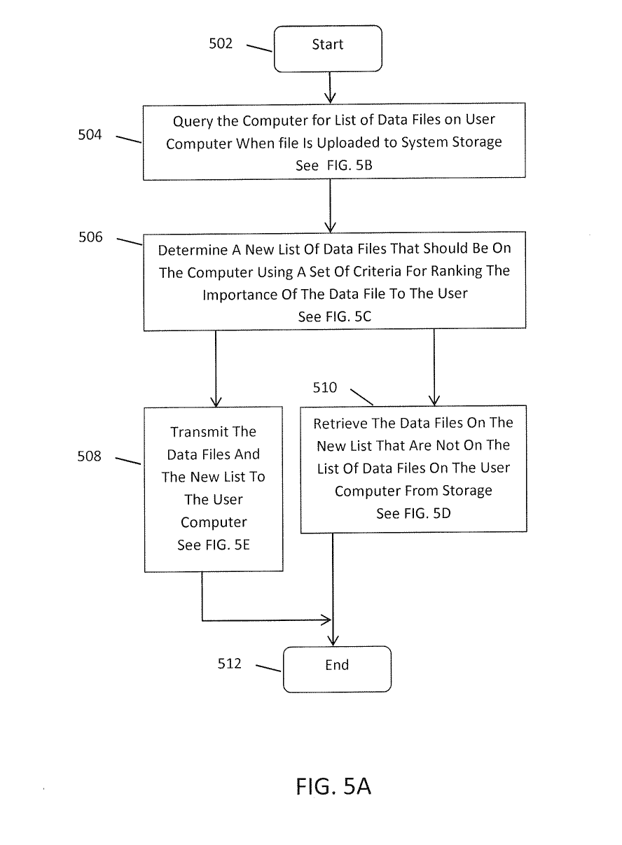

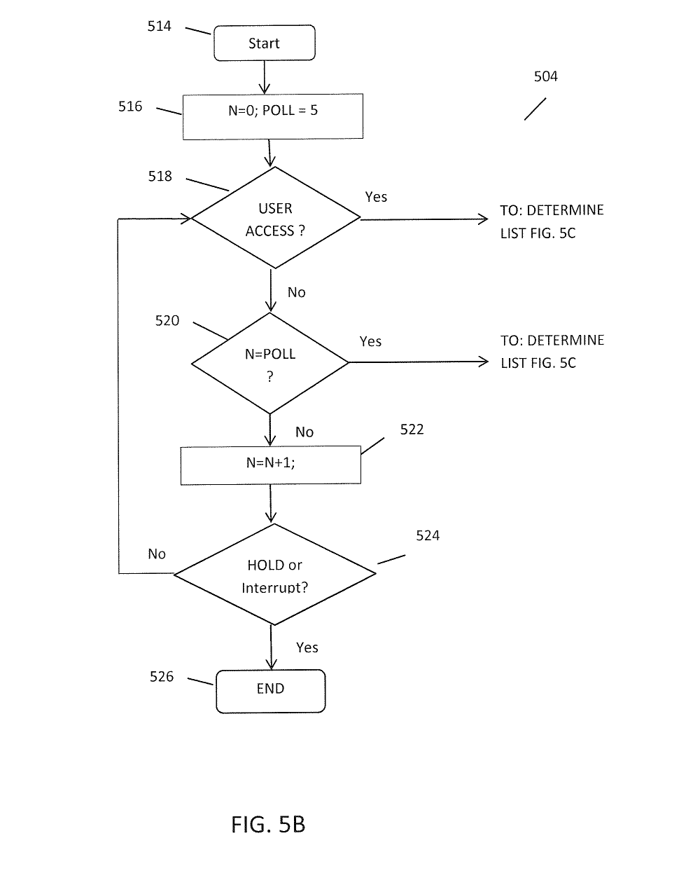

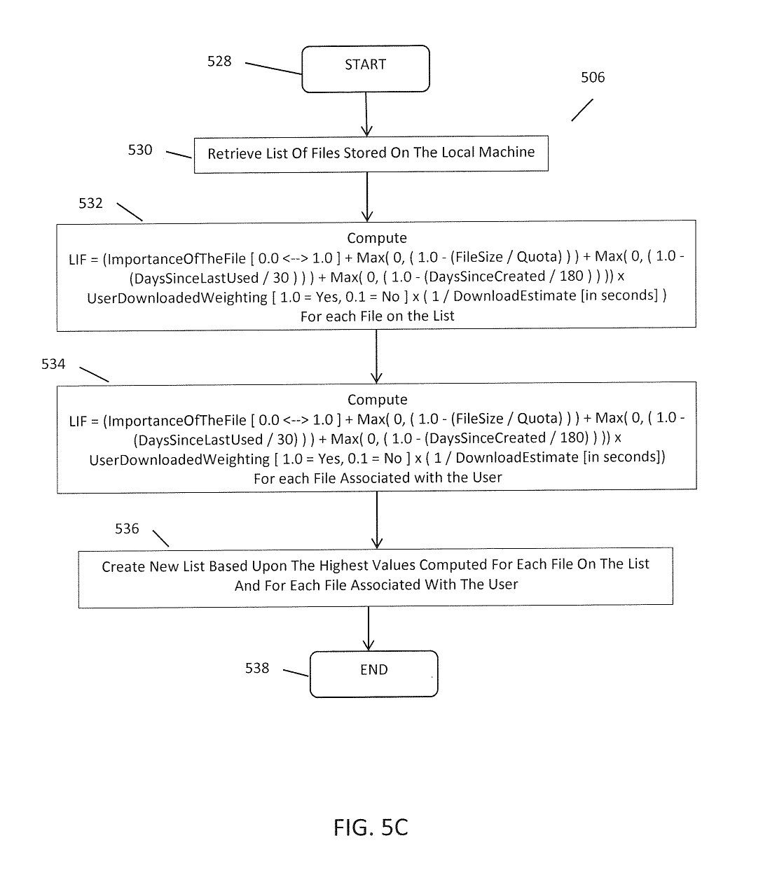

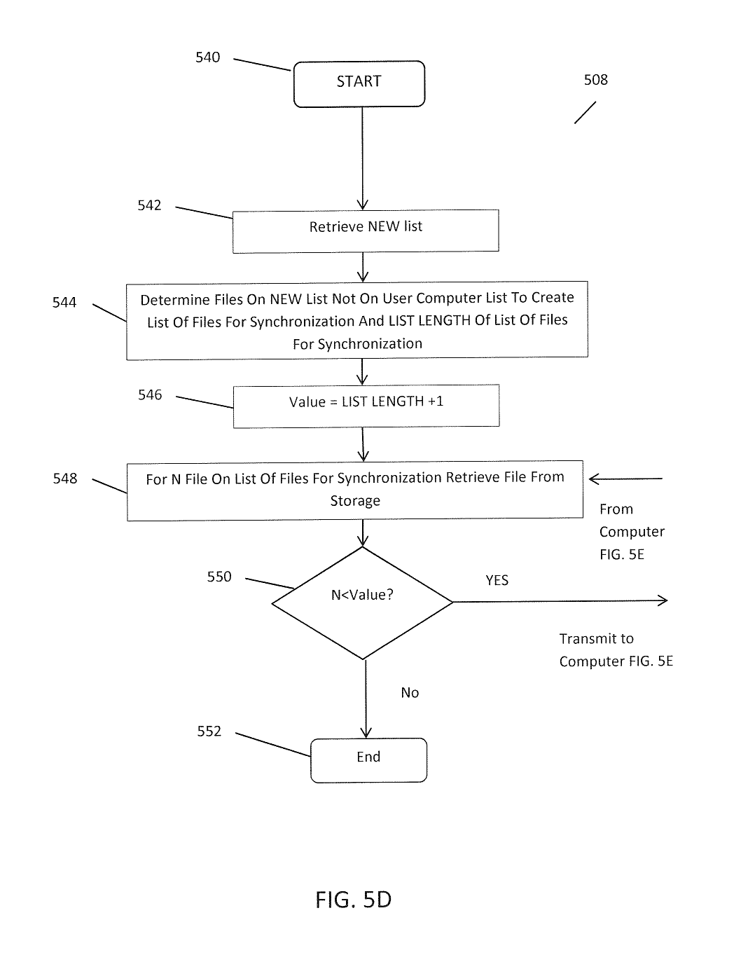

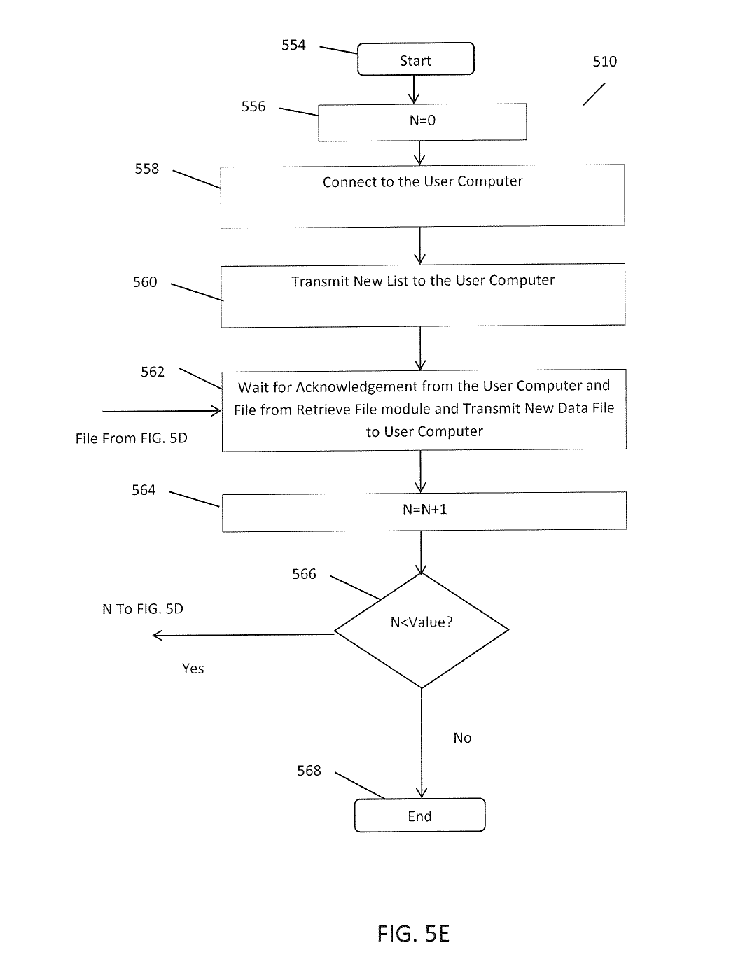

An exemplary embodiment of the computer program flow for the instructions implementing the retrieve list module 302, the determination module 304, the retrieve file module 306, and the transmit files module 308 will now be described with reference to FIGS. 5A-5E. As one skilled in the art will appreciate, though the flow diagrams are shown as implemented in a serial configuration (or a combination of serial and parallel configurations), such flow is for simplicity only and should be understood to include various loops and processes that may be run separately and/or concurrently and/or used to implement each of the instructions, or a plurality of the instructions, therein.

In general, the software flow for the server begins at step 502. In step 504, the company computer 106 queries the user computer 102 for a list of files stored thereon. For example, the company computer 106 may query the user computer 102 for the list of files in response to a request to save or download a file from the user computer 102. In some embodiments, the company computer 106 may query the user computer 102 at regular intervals or poll the user computer for file updates. In other embodiments, when the user computer connects to the company computer (e.g., when a user logs into the company computer 106 via the user computer 102), the company computer 106 may request the list of files stored on the user computer 102. Embodiments of step 504 are described in more detail in FIG. 5B. In step 506, the process includes the step of determining a new list of data files that should be on the computer using a set of criteria for ranking the importance of the data file to the user. An embodiment of these step 506 is discussed in more detail in FIG. 5C. After the new list is determined, in step 510, the data files on the new list, which are not on the list of files that are stored in the user computer, are retrieved. An embodiment of step 510 is described in more detail in FIG. 5D. Also after the new list is determined, in step 508, the data files and new list are transmitted to the user computer for storage. Step 508 is described in more detail in FIG. 5E. In step 512, the process ends.

FIG. 5B shows process 504 (FIG. 5A) for retrieving a list of files from the user computer to implement the retrieve list module 302 according to an embodiment of the invention. In step 514, the process starts, and in step 516, a variable N is set to equal zero and a variable Poll is set to a number (e.g., 5). For example, variable N may be a loop counter for the number of times a series of steps in the process 504 repeat without querying a user computer for a list of files. The variable Poll may indicate a time when the retrieve list module 302 queries the user computer for a list of files. In step 518 the process queries whether a user has accessed the company computer 106. If the user has accessed the company computer 106, the process calls the determine list module shown in FIG. 5C. If the user has not accessed the company computer 106, the process moves to 520 where the process determines whether that value of variable N equals the value of variable Poll (i.e., N=Poll). If the variables N and Poll are equal, the process calls the determine list module shown in FIG. 5C. If the variables N and Poll are not equal, the process moves to step 522 where the process increments the variable N by one. In step 524, the process determines whether or not the process is to be held or interrupted. The process, for example, may hold the process, or execute an interrupt, for the reception of a file or for another process. For example, the loop may be interrupted because the computer is not identified on the network, other processes are being serviced by the company computer, etc. If the process is not to be held or interrupted, the process returns to step 518. If the process is be held or interrupted, the process ends in step 526.

FIG. 5C shows process 506 (FIG. 5A) for determining a new list of files to be synchronized to the user computer. Process 506 implements the determination module 304 according to an embodiment of the invention. The process begins at step 528. At step 530, the process retrieves the list of files from the user computer 102. In step 532, the process computes, for each of the files on the retrieved list, the ranking of the file Locally Importance Factor (“LIF”). The files are ranked according to a particular criteria to determine which files should be synchronized, and thereby stored, on the user computer 102. In this regard, in some embodiments, the company computer will not synchronize all of the files that should be stored on the user computer 102, but only the ones that have been updated or are not currently saved thereon. For example, the process can be set for a company or organization to optimize a rank for the files that are most likely to be needed by its employees. In such embodiments, the variables that determine the rankings may be optimized to take account of documents that are most frequently accessed by users with a certain title or in a certain department, that are most frequently accessed by the user and/or the user's supervisors, or any other suitable criteria or combination of criteria (e.g., as described in connection with Eq. 1 above). An algorithm, based on a combination of different criteria and different weighting factors applied to each criteria, is used to determine a rank for each file. A weighting factor is a numerical value, between one and zero, that is assigned to a particular criteria. For example, if a criteria is considered very important to the ranking, it may be assigned a weight of 0.9, while another criteria, considered less important to the ranking, may be assigned a weight of 0.2. In this way, the synchronization software can be customized for the user, company, organization, etc. In this regard, an embodiment of an algorithm for computing the ranking of a file, with the range of possible weighting factors for each variable, may be:

LIF=(ImportanceOfTheFile[0.0<- ->1.0]+Max(0,(1.0−(FileSize/Quota)))+Max(0,(1.0−(DaysSinceLastUsed/30)))+Max(0,(1.0−(DaysSinceCreated/180))))×UserDownloadedWeighting[1.0=Yes,0.1=No]×(1/DownloadEstimate[in seconds]) (Eq. 1)
Where:
ImportanceOfTheFile is the variable indicating the level of importance the file is to the user (e.g., a file accessed often by the user, related to a user's job function, etc.);
FileSize is the variable indicating the size of the file (e.g., to make sure the list does not exceed the memory of the user computer 102 and to reduce download time);
DaysSinceLastUsed is the variable indicating the number of days since the user last accessed the file;
DaysSinceCreated is the variable indicating the number of days since the user created the file;
UserDownloadedWeighting is the variable indicating whether or not the user has designated the file for storage in the memory of the user computer 102; and
DownloadEstimate is the variable indicating the time it will take to download a file from the company computer 106 or associated storage 108. The can be measured in seconds or any other suitable metric.

In some embodiments, the equation can include additional variables, fewer variables, or any suitable combination of variables. For example, other variables may be defined for files that are templates or forms for a department that are associated with the user, the number of users that have accessed the file, whether the user and their supervisor are accessing the same document, the folder or drive the user has used to save the file, etc. In other embodiments, the equation can provide any suitable weighting factors or no weighting factors to each of the variables in the equation.

In step 534, the instructions include computing, for the files associated with the user, the ranking of the file, LIF, using in some embodiments the same or different equation, variables, and/or weighting factors as defined above. To reduce the number of files for ranking, in some embodiments, the system may narrow the number of files associated with the user to those that the user has identified as an associated file, those saved by other users that are in the user's department or office location, files the user has accessed, files that the user has edited, files related to forms and templates that are used by the user, or any other suitable criteria or combination of criteria. After the number of files that may be ranked for a particular user are filtered, in such embodiments, the variables in the algorithm that determine the rankings may be optimized to take account of documents that are most frequently accessed by users with a certain title or in a certain department, that are most frequently accessed by the user and/or the user's supervisors, or any other suitable criteria or combination of criteria (e.g., as described in connection with Eq. 1 above or Eq. 2 below). In this regard, an embodiment of an algorithm for computing the ranking of a file, with the range of possible weighting factors for each variable, may be:

LIF=(ImportanceOfTheFile[0.0<- ->1.0]+Max(0,(1.0−(FileSize/Quota)))+Max(0,(1.0−(DaysSinceLastUsed/30)))+Max(0,(1.0−(DaysSinceCreated/180))))×UserDownloadedWeighting[1.0=Yes,0.1=No]×(1/DownloadEstimate) (Eq. 2)

In some embodiments, the equation can include additional variables, fewer variables, or any suitable combination of variables and weighting factors. For example, other variables may be defined for files that are templates or forms for a department that are associated with the user, the number of users that have accessed the file, whether the user and their supervisor are accessing the same document, the folder or drive the user has used to save the file, etc. To determine files to which the user is associated, in some embodiments the process will determine all files that the user has accessed or created within a particular time period, or files that are associated with a group or department of which the user is a member. In this way, the process can reduce the number of possible files that may be associated with the user, before running the aforementioned calculations. In step 536, the process creates a new list based upon the highest LIF value, or ranking, for each file on the list and the number of files that the user computer 102 is able to store. For example, the user computer may only have a limited amount of memory, or only a specific amount of memory reserved for files from the company computer 106. In step 538, the process ends.

FIG. 5D shows process 508 (FIG. 5A) for retrieving files to be synchronized to the user computer. Process 508 implements the retrieve file module 306 according to an embodiment of the invention. In step 540, the process starts. In step 542, the process retrieves the new list from the determination module 304. In step 544, the process determines the files on the new list that were not on the list of files retrieved from the user computer 102 to create a list of files for synchronization and also determines the length of the list of files for synchronization (LIST LENGTH). In step 546, the process sets a variable called “Value”, a loop counter, to be equal to the LIST LENGTH+1 (e.g., so the process does not stop retrieving files until the loop counter has exceeded the number of new files that need to be retrieved). In step 548, the process retrieves each N file (see FIG. 5E). For example, N represents from the list of files for synchronization. In step 550, the process determines whether N is less than Value. If N is less than Value, then the file is transferred to the transmit file module 308 (see FIG. 5E). If N is not less than Value (i.e., N is the same as or greater than Value), then the process ends in step 552.

FIG. 5E shows process 508 (FIG. 5A) for transmitting the new files to be synchronized to the user computer. Process 508 implements the transmit module 308 according to an embodiment of the invention. The instructions for the transmit files module 308 begin at step 554. At step 556, the process sets N to be zero. In step 558, the process connects the company computer 106 to the user computer 102. In step 560, the process transmits to the user computer 102 the new list of files (e.g., NEW list), along with the number of new files the user computer can expect to download (e.g., LIST LENGTH). In step 562, the company computer waits for acknowledgement from the user computer that the new list of files has been received. The acknowledgement may also include an indication as to whether the files that are not on the new list have been deleted from the user computer memory. Once the acknowledgement is received, files from the retrieve file module 306 and transmits the new data file to the user computer. After the file is transferred to the user computer 102, the process increments N by one in step 564. At step 566, the process determines whether N is less than Value. If N is less than Value, N is transmitted to the retrieve file module 306 (FIG. 5D) in step 566. If N is not less than Value (i.e., N is equal to or greater than Value), the process ends in step 568. As one skilled in the art will appreciate, the retrieve file module 306 and the transmit file module 308 work in conjunction with one another to transmit a file to the user computer 102. As such, each of these modules may call variables and data from the other modules.

User computer 102 will now be described with reference to FIG. 2B. As one skilled in the art will appreciate, user computer 102 can be any type of computer such as a virtual computer, application server, or a plurality of computers (e.g., a dedicated computer server, desktop, laptop, personal digital assistant (PDA), cellular telephone such as a Smartphone, computer tablet, WebTV, as well as any other electronic device). As such, user computer 102 may comprise a memory 206B, a program product 208B, a processor 204B and an input/output (“I/O”) device 202B. I/O device 202B connects the user computer 102 to a signal from the communications network 104, and can be any I/O device including, but not limited to a network card/controller connected by a bus (e.g., PCI bus) to the motherboard, or hardware built into the motherboard to connect the user computer 102 to various file servers or database servers implementing storage 108.

As can be seen, the I/O device 202B is connected to the processor 204B. Processor 204B is the “brains” of the user computer 102, and as such executes program product 208B and works in conjunction with the I/O device 202B to direct data to memory 206B and to send data from memory 206B to the various file servers and communications network. Processor 204B can be, for example, any commercially available processor, or plurality of processors, adapted for use in user computer 102 (e.g., Intel® Xeon® multicore processors, Intel® micro-architecture Nehalem, AMD Opteron™ multicore processors, etc.). As one skilled in the art will appreciate, processor 204B may also include components that allow the user computer 102 to be connected to a display (not shown), keyboard, mouse, trackball, trackpad and/or any other user input device, that would allow, for example, an administrative user direct access to the processor 204B and memory 206B.

Memory 206B may store the algorithms forming the computer instructions of the instant invention and data, and such memory 206B may include both non-volatile memory such as hard disks, flash memory, optical disks, and the like, and volatile memory such as SRAM, DRAM, SDRAM, and the like, as required by embodiments of the instant invention. As one skilled in the art will appreciate, though memory 206B is depicted on, for example, the motherboard of the user computer 102, memory 206B may also be a separate component or device connected to the user computer 102. For example, memory 206B may be flash memory or other storage.

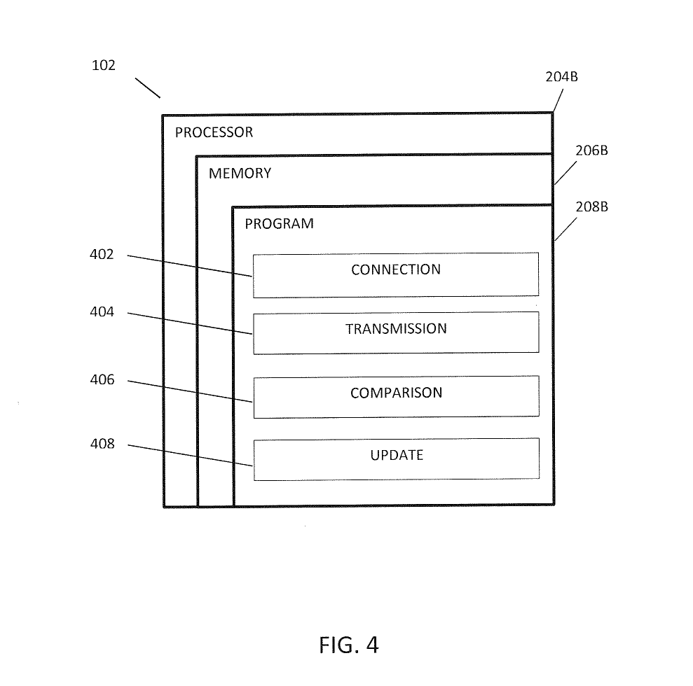

As shown in FIG. 2B, an embodiment for computer instructions implementing programming module 208B and some of the functionality of the instant invention for the user computer 102 is stored in memory 206B (e.g., as a plurality of programming modules). Turning now to FIG. 4, the programming modules of the computer program product 208B stored in memory 206B may include a connection module 402, a transmission module 404, a comparison module 406, and an update module 408.

The connection module 402 can include instructions that enable the user computer 102 to connect to the company computer 106 through the communication network 104. The transmission module 404 can include instructions that enable the user computer to transmit a list of files stored thereon to the company computer 106. For example, the transmission module 404 can transmit a list of all files stored in all or a portion of the memory of the user computer 102 (e.g., the user computer may have a portion of its memory dedicated to receiving files from and synchronizing files with the company computer 106).

The comparison module 406 can include instructions that enable the user computer 102 to compare a list of files received from the company computer 106 with a list of files currently stored thereon, and to delete from memory those files that are no longer needed in user computer 102. For example, as part of the process of deleting files, the user computer 102 can transmit the files to be deleted prior to deleting same so that the latest version of the deleted file is stored in with the company computer 106 or the attached storage 108. As one skilled in the art will appreciate, the user may also be asked whether or not to delete the file and/or whether to transmit the file to the company computer 106. The update module 408 can include instructions to update the files stored on the user computer 102 by copying files received from the company computer 106.

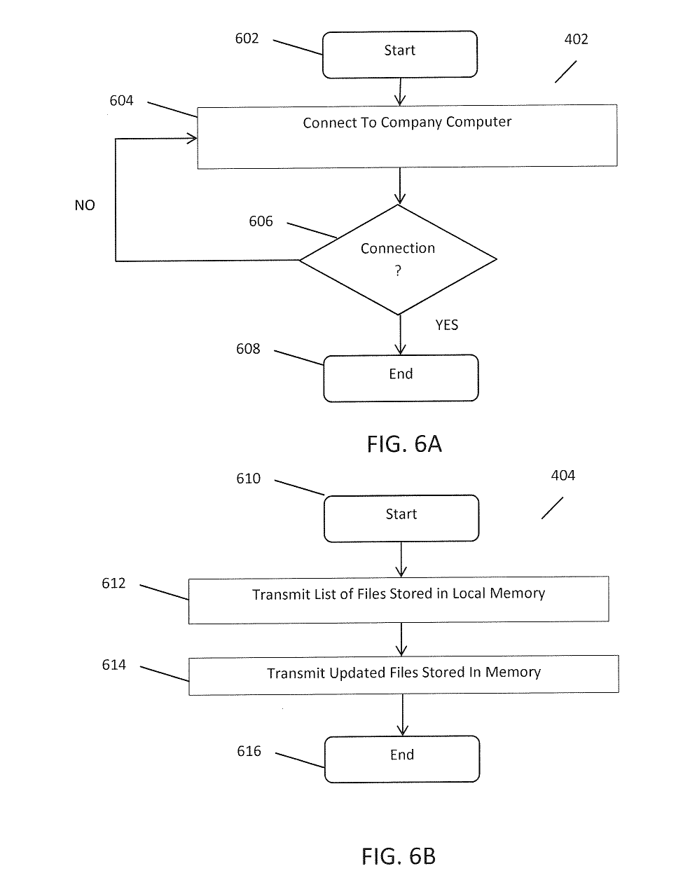

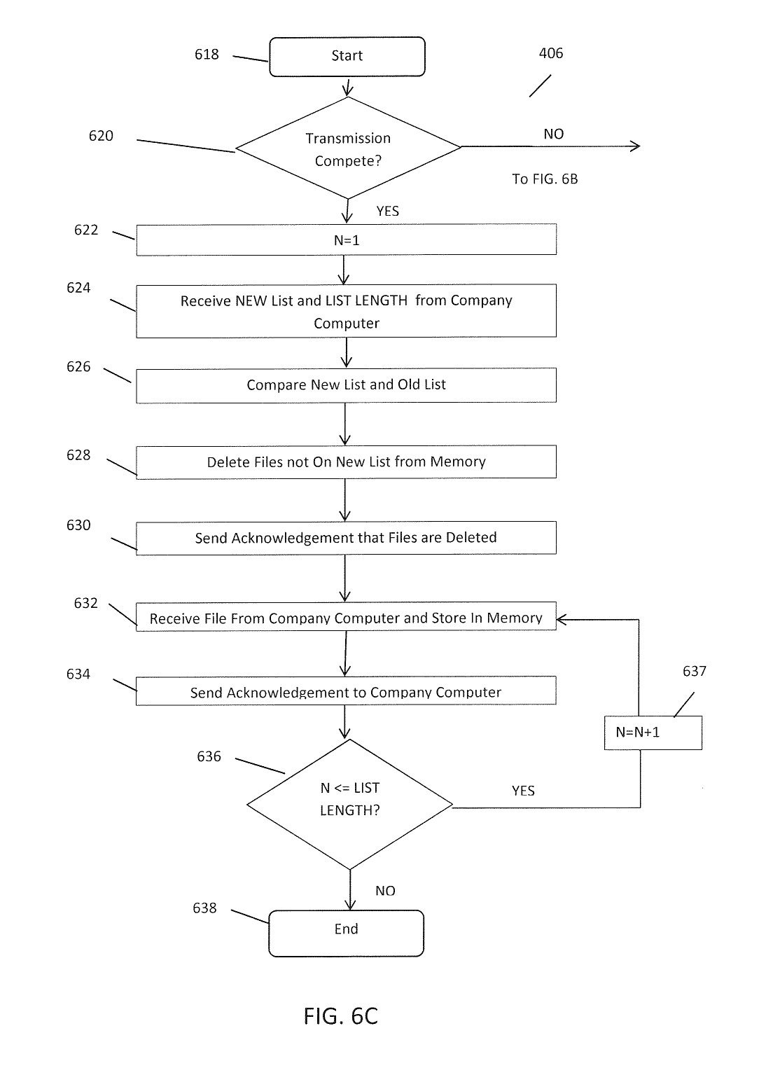

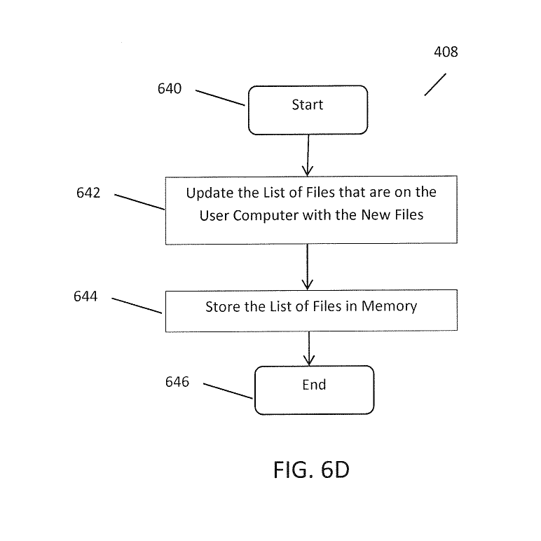

An exemplary embodiment of the computer program flow for processes implementing a connection module 402, a transmission module 404, a comparison module 406, and an update module 408 will now be described with reference to FIGS. 6A-6D. As one skilled in the art will appreciate, though the flow diagrams are shown as implemented in a serial configuration (or a combination of serial and parallel configurations), such flow is for simplicity only and should be understood to include various loops and processes that may be run separately and/or concurrently and/or used to implement each of the instructions, or a plurality of the instructions, therein.

An exemplary embodiment of the connection module 402 is described with reference to FIG. 6A. The process starts in step 602. In step 604, the user computer 102 connects to the company computer 106. For example, the user computer 102 may connect to the company computer to upload a file, for regular polling, or to fetch a file from the company computer 106 memory or storage 108. In step 606, the user computer 102 determines whether a connection has been established with the company computer 106. If a connection is not established, the process returns to step 604 where the user computer 102 again attempts to connect to the company computer 106. If a connection is established, the process ends in step 608.

An exemplary embodiment of the transmission module 404 is described with reference to FIG. 6B. In step 610, the process starts. In step 612, the user computer 102 transmits a list of files stored in its memory to the company computer 106. In step 614, the computer also transmits updated files that are stored in memory. In some embodiments, however, the updated files may be transmitted concurrently with the list of stored, or may be transmitted when the connection with the company computer 106 is established. For example, the step of transmitting updated files to the company computer 106 may be part of the connection module 402. As part of this step, in some embodiments, the transmit module may set a flag indicating that all of the updated files have been sent to the company computer 106 for storage, either in the company computer 106 or the storage 108. In step 616, the process ends.

Turning to FIG. 6C, the instructions implementing an embodiment of the comparison module 406 are described. The process starts at step 618, and in step 620, the process determines whether a transmission that initiated the user computer connecting to the company computer 106 is complete. For example, after a connection with the company computer 106 is established, the user computer 102 may upload any updated files to the company computer 106 before file synchronization begins to ensure that all of the files on the user computer 102 are saved before they are possibly replaced. Once it is finished, the transmission module 404 may set a flag indicating that the user computer 102 is ready to start the file synchronization process, and step 620 may determine whether such a flag has been set. For example, such a flag may indicate to the company computer that it is okay to begin synchronization, and thereby can write over files that are stored on the user computer. In step 622, a variable N, a loop counter, is set to 1. In step 624, the user computer 102 receives the NEW list and the LIST LENGTH from the company computer 106. For example, NEW list may be the entire list of files the user computer 102 should have stored on the computer when the synchronization is complete. The LIST LENGTH may indicate the number of batches of files the user computer 102 can expect to receive from the company computer 106 (e.g., each batch of files may include one or more files or file folders). In step 626, the user computer 102 compares the NEW list with the list stored in user computer memory. Then in step 628, the user computer 102 deletes any files that are not on the NEW list from its computer memory. In step 630, the user computer 102 sends an acknowledgement to the company computer 106 that the files are deleted. In step 632, the user computer 102 begins to receive data files from the company computer 106. For example, the user computer 102 may receive the data files individually, in batches, per folder, etc. In step 634, the user computer 102 sends an acknowledgement to the company computer 106 that the one or more files or file folders have been stored in the user computer 102. In step 636, the process determines whether N is less than or equal to LIST LENGTH, to determine whether or not to exit the loop. If N is less than or equal to LIST LENGTH, the process increments N by one in step 637, and returns to step 632 to receive a next batch of files. If N is greater than LIST LENGTH, then the process ends in step 638.

Turning to FIG. 6D, the instructions implementing an embodiment of the update file module 408 are described. The process starts in step 640. In step 642, the process updates the list of files that are not on the user computer 102 with the new files. In step 644, the instructions store the list of files in memory. The process ends in step 646.

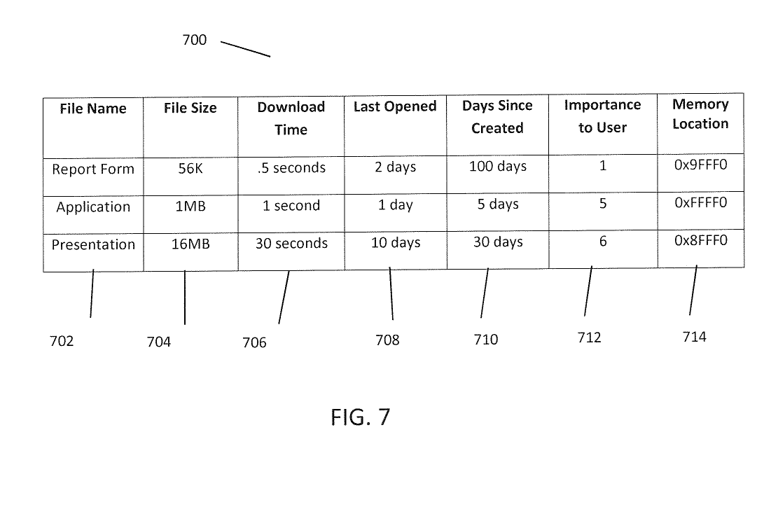

An exemplary list of files is shown in FIG. 7. In some embodiments, the list 700 may be a table of values that includes the parameters used in Eq. 1 and Eq. 2 above. For example, the table may include one or more values for the file name 702, the file size 704, the estimated download time for the file 706, the time since the file was last opened 708, the days since the file was last created 710, the importance of the file to the user 712, and the memory location 714 in the company computer 106 or the storage 108. Such a table is exemplary only and can include additional values, less values, or any other suitable combination of values. For example, memory location 714 may be omitted in embodiments where each of the files are obtained from a hard disk. This column may indicate whether the file is on the hard disk, and the values in the column could be yes or no. The table may also include any other suitable format, including a sequential list. For example, the values associated with days since last opened 708 and/or days since the file was last created 710 could be the number of months, weeks, hours, minutes, seconds, or could simply be the time stamp (including date and actual time of last access). In some embodiments, the list shown in 700 may be stored in the company computer 106, the storage 108, or the user computer 102. However, in other embodiments one or more of the parameters in the table may be stored in only one or more of the company computer 106, the storage 108, or the user computer 102. In some other embodiments, the values stored in the table 700 may be split and stored partially in two or more of the company computer 106, the storage 108, or the user computer 102.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A system for synchronizing data files, the system comprising:
a computer having a processor and a tangible, non-transitory computer memory with instructions operable therein for performing on the processor a process of determining data files that should be synchronized with a user computer and a process of synchronizing the data files, the instructions comprising the steps of:
receiving a local list of data files stored in the user computer;
responsive to receiving the local list, determining a set of data files associated with a user;
determining a rank for each data file in the set based on at least one of:
whether the user is associated with another user that has recently created the data file, and
whether the data file can be downloaded within a predefined time period;
creating a ranked list ordered by the rank determined for each data file in the set;
creating a new list of data files from the data files associated with higher ranks in the ranked list, the data files in the new list having a cumulative size that is less than a memory size of the user computer; and
comparing the new list with the local list to determine which of the data files in the new list are missing from the user computer.

2. The system of claim 1, wherein the computer memory includes the instructions that further comprise the step of:
retrieving the data files that are missing from the user computer from the computer memory; and
transmitting the data files that are missing to the user computer for storage.

3. The system of claim 1, further comprising a secondary storage device having a tangible, non-transitory memory for storing the data files,
wherein an entry for each of the data files in the new list includes a memory location associated with the secondary storage device, and
wherein the computer memory includes the instructions that further comprise the step of:
using at least the memory location to retrieve from the secondary storage device the data files that are missing, and
transmitting the data files that are missing to the user computer.

4. The system of claim 1 wherein the rank is further determined by at least one of:
whether the user has recently accessed the data file;
whether the user has recently created the data file; and
whether the user has ranked the data file as important.

5. The system of claim 1, wherein the computer memory includes instructions that further comprise the step of:
dividing the data files that are missing into at least a first batch and a second batch, each including at least one data file;
transmitting the first batch to the user computer;
waiting for an acknowledgement from the user computer that the first batch was received; and
in response to receiving the acknowledgement, transmitting the second batch to the user computer.

6. The system of claim 5, wherein the computer memory includes instructions that further comprise the step of:
transmitting the new list of data files to the user computer; and
waiting for an acknowledgement from the user computer that the new list has been received, and that data files stored on the user computer that are missing from the new list have been deleted.

7. The system of claim 5, wherein the computer memory includes instructions comprising the step of:
determining whether the user computer has connected to the computer to retrieve one of the data files, to poll the computer for user updates, or to save a new data file to computer memory; and
requesting the local list from the user computer if the user computer has connected to the computer to poll the computer for user updates or to save the new data file to computer memory.

8. A computer program product operable on a computer having a tangible, non-transitory computer memory, the computer program product causing the computer to perform a process of determining data files that should be synchronized with a user computer and a process of synchronizing the data files, the computer program product executing instructions comprising the steps of:
receiving a local list of data files stored in the user computer;
responsive to receiving the local list, determining a set of data files associated with a user;
determining a rank for each data file in the set based on at least one of:
whether the user is associated with another user that has recently created the data file, and
whether the data file can be downloaded within a predefined time period;
creating a ranked list ordered by the rank determined for each data file in the set;
creating a new list of data files from the data files associated with higher ranks in the ranked list, the data files in the new list having a cumulative size that is less than a memory size of the user computer; and
comparing the new list with the local list to determine which of the data files in the new list are missing from the user computer.

9. The computer program product of claim 8, wherein the instructions further comprise the step of:
retrieving the data files that are missing from the user computer from the computer memory; and
transmitting the data files that are missing to the user computer for storage.

10. The computer program product of claim 8,
wherein an entry for each of the data files in the new list includes a memory location associated with a secondary storage device, and
wherein the computer program product includes the instructions that further comprise the step of:
using at least the memory location to retrieve from the secondary storage device the data files that are missing, and
transmitting the data files that are missing to the user computer.

11. The computer program product of claim 8, wherein the rank is further determined by at least one of:
whether the user has recently accessed the data file;
whether the user has recently created the data file; and
whether the user has ranked the data file as important.

12. The computer program product of claim 8, wherein the instructions further comprise the step of:
dividing the data files that are missing into at least a first batch and a second batch, each including at least one data file;
transmitting the first batch to the user computer;
waiting for an acknowledgement from the user computer that the first batch was received; and
in response to receiving the acknowledgement, transmitting the second batch to the user computer.

13. The computer program product of claim 12, wherein the instructions further comprise the step of:
transmitting the new list of data files to the user computer; and
waiting for an acknowledgement from the user computer that the new list has been received, and that data files stored on the user computer that are missing from the new list have been deleted;

14. The computer program product of claim 12, wherein the instructions further comprise the steps of:
determining whether the user computer has connected to the computer to retrieve one of the data files, to poll the computer for user updates, or to save a new data file to computer memory; and
requesting the local list from the user computer if the user computer has connected to the computer to poll the computer for user updates or to save the new data file to computer memory.

15. A computer implemented method causing a computer to perform a process of determining data files that should be synchronized with a user computer and a process of synchronizing the data files, the computer-implemented method comprising the steps of:
receiving a local list of data files stored in the user computer;
responsive to receiving the local list, determining a set of data files associated with a user;
determining a rank for each data file in the set based on at least one of:
whether the user is associated with another user that has recently created the data file, and
whether the data file can be downloaded within a predefined time period;
creating a ranked list ordered by the rank determined for each data file in the set;
creating a new list of data files from the data files associated with higher ranks in the ranked list, the data files in the new list having a cumulative size that is less than a memory size of the user computer; and
comparing the new list with the local list to determine which of the data files in the new list are missing from the user computer.

16. The computer-implemented method of claim 15, further comprising the steps of:
retrieving the data files that are missing from the user computer from the computer memory; and
transmitting the data files that are missing to the user computer for storage.

17. The computer-implemented method of claim 15,
wherein an entry for each of the data files in the new list includes a memory location associated with a secondary storage device, and
wherein the computer program product includes the instructions that further comprise the step of:
using at least the memory location to retrieve from the secondary storage device the data files that are missing, and
transmitting the data files that are missing to the user computer.

18. The computer-implemented method of claim 15, wherein the rank is further determined by at least one of:
whether the user has recently accessed the data file;
whether the user has recently created the data file; and
whether the user has ranked the data file as important.

19. The computer-implemented method of claim 15, further comprising the steps of:
dividing the data files that are missing into at least a first batch and a second batch, each including at least one data file;
transmitting the first batch to the user computer;
waiting for an acknowledgement from the user computer that the first batch was received; and
in response to receiving the acknowledgement, transmitting the second batch to the user computer.

20. The computer-implemented method of claim 15, further comprising the steps of:
transmitting the new list of data files to the user computer; and
waiting for an acknowledgement from the user computer that the new list has been received, and that data files stored on the user computer that are missing from the new list have been deleted.
